(19) United States
(12) Patent Application Publication
(10) Pub. No.: US 2007/0212578 A1
(43) Pub. Date: Sep. 13, 2007

(54) DIRECT LIQUID FUEL CELL COMPRISING A HYDRIDE FUEL AND A GEL ELECTROLYTE

(75) Inventors: Alexander BLUVSTEIN, Lod (IL); Yuri KATSMAN, Hadera (IL)

Correspondence Address: GREENBLUM & BERNSTEIN, P.L.C., 1950 ROLAND CLARKE PLACE, RESTON, VA, 20191, US

(73) Assignee: MORE ENERGY LTD., Lod (IL)

(21) Appl. No.: 11/684,328

(22) Filed: Mar. 9, 2007

Related U.S. Application Data
(60) Provisional application No. 60/781,340, filed on Mar. 13, 2006.

(51) Int. Cl. H01M 8/06; H01M 8/08; H01M 8/10

(52) U.S. Cl. 429/19; 429/46; 429/33

(57) ABSTRACT

A direct liquid fuel cell which comprises a gel electrolyte and a liquid fuel. The liquid fuel comprises a metal hydride compound and/or a borohydride compound. This Abstract is neither intended to define the invention disclosed in this specification nor intended to limit the scope of the invention in any way.

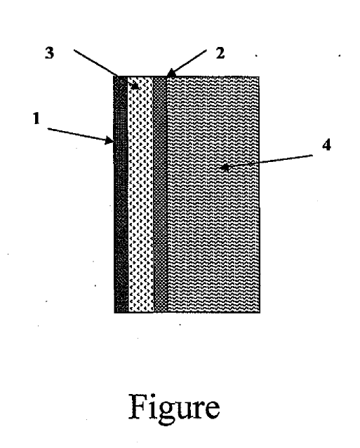

### CROSS-REFERENCE TO RELATED APPLICATIONS

The present application claims priority under 35 U.S.C. §119(e) of U.S. Provisional Application No. 60/781,340, filed Mar. 13, 2006, the entire disclosure whereof is expressly incorporated by reference herein.

### BACKGROUND OF THE INVENTION

1. Field of the Invention

The present invention relates to a Direct Liquid Fuel Cell (DLFC) which comprises a liquid hydride or borhydride fuel and a gel electrolyte.

2. Discussion of Background Information

Direct liquid fuel cells are of considerable importance in the field of new energy conversion technologies. In the literature, the most frequently discussed liquid fuel for a DLFC appears to be methanol. The main disadvantages of Direct Methanol Fuel Cells (DMFCs) include the toxicity of methanol, the very poor discharge characteristics at room temperature and the complexity and cost due to high catalyst loading and poor performance.

Fuels based on (metal) hydride and borohydride compounds (hereafter sometimes collectively referred to as “hydride fuels”) such as, erg., sodium borohydride (e.g., in alkaline solution) have a very high chemical and electrochemical activity. Consequently, DLFCs which use such fuels have extremely high discharge characteristics (current density, specific energy, etc.) even at room temperature. There is, however, still room for improvement.

Probably the most frequently used electrolyte for DLFCs based on hydride (and other) fuels is a liquid, i.e., an aqueous alkali hydroxide solution, usually an aqueous KOH or NaOH solution. Problems associated with this type of electrolyte include water loss or gain (through evaporation of water or hydration), potential leakage of a highly corrosive liquid from the fuel cell, need for a relatively large (thick) electrolyte compartment, and design issues in the case of a refillable fuel cell. These problems are particularly pronounced in the case of a portable DLFC.

In view of the foregoing, it would be advantageous to have available a DLFC with an electrolyte that does not show the disadvantages associated with a conventional liquid electrolyte and preferably, shows additional advantages such as, e.g., an increased power output in comparison to the liquid electrolyte.

### SUMMARY OF THE INVENTION

The present invention provides a direct liquid fuel cell which comprises a gel electrolyte and a liquid fuel. The liquid fuel comprises a metal hydride compound and/or a borohydride or polyborohydride compound.

In one aspect, the fuel cell may be a portable fuel cell (e.g., for use in portable electronic devices such as cell phones and laptop computers) and/or it may be a refillable fuel cell.

In another aspect, the gel electrolyte may comprise an aqueous gel electrolyte, e.g., an alkaline aqueous gel electrolyte. For example, the alkaline aqueous gel electrolyte may comprise an inorganic hydroxide such as, e.g., an alkali metal hydroxide.

In yet another aspect, the gel electrolyte of the fuel cell of the present invention may comprise at least one gelling agent. This gelling agent may comprise an organic polymer such as, e.g., one or more of a cross-linked polyacrylic acid and a salt thereof, a cross-linked polyacrylamide, an alkali saponified polyacrylonitrile, xanthan gum, guar gum a starch graft copolymer, a HASE polymer, and carboxymethylcellulose. In another aspect, the at least one gelling agent may further comprise a matrix material which may, for example, be selected from cellulose esters, polyacrylates, polyvinyl esters, acrylate/vinyl ester copolymers and combinations thereof.

In a still further aspect, the gel electrolyte of the fuel cell of the present invention may comprise a particulate material which may, for example, comprise a powder and/or fibers. The particulate material may, for example, be selected from one or more of cellulose, silica, silicon carbide, alumina, zirconia, a clay mineral, polystyrene, polyethylene and a polystyrene-divinylbenzene copolymer.

In another aspect of the fuel cell of the present invention, the gel electrolyte may have a thickness of not more than about 2 mm and/or may be present as a paste and/or may have a conductivity of at least about 10⁻³ S/cm.

In yet another aspect of the fuel cell of the present invention, the liquid fuel may comprise a borohydride compound such as, e.g., one or more of NaBH₄, KBH₄, LiBH₄, Be(BH₄)₂, NH₄BH₄, a polyborohydride, Ca(BH₄)₂, Mg(BH₄)₂, Zn(BH₄)₂, Al(BH₄)₃, (CH₃)₂NHBH₃ and NaCNBH₃. For example, the liquid fuel may comprise an alkali metal borohydride. In another aspect, the liquid fuel may comprise water and/or an alkali metal hydroxide. Also, the liquid fuel may comprise a solution and/or a dispersion.

In a still further aspect, the fuel cell of the present invention may comprise an air-breathing cathode and/or an anode which comprises a gas-blocking layer on a side thereof which faces the gel electrolyte and/or an anode which has been subjected to a hydrophilization treatment.

The present invention also provides a direct liquid fuel cell which is portable and comprises (i) a gel electrolyte comprising water, an basic inorganic compound and at least one polymeric gelling agent and (ii) a liquid fuel comprising water and a borohydride compound.

In one aspect, the fuel cell may be refillable.

In another aspect, the gel electrolyte may comprise an alkali metal hydroxide such as, e.g., KOH.

In yet another aspect, the at least one polymeric gelling agent may comprise one or more of a cross-linked polyacrylic acid and a salt thereof, a cross-linked polyacrylamide, an alkali saponified polyacrylonitrile, xanthan gum, guar gum, a starch graft copolymer, a HASE polymer and carboxymethylcellulose. In another aspect, the at least one gelling agent may further comprise a matrix material such as, e.g., a cellulose ester, a polyacrylate, a polyvinyl ester, an acrylate/vinyl ester copolymer or a combination of two or more of the foregoing.

In a still further aspect, the gel electrolyte of the fuel cell of the present invention may have a thickness of not more than about 1 mm and a conductivity of at least 10⁻³ S/cm. In another aspect, the gel electrolyte may be present as a paste.

In another aspect of the fuel cell of the present invention, the borohydride compound may comprise one or more of NaBH₄, KBH₄, LiBH₄, Be(BH₄)₂, NH₄BH₄, a polyborohydride, Ca(BH₄)₂, Mg(BH₄)₂, Zn(BH₄)₂, Al(BH₄)₃, (CH₃)₂NHBH₃ and NaCNBH₃. For example, it may comprise NaBH₄. In yet another aspect, the liquid fuel may further comprise an alkali metal hydroxide.

In another aspect, the fuel cell may comprise an air-breathing cathode and/or an anode which has a gas-blocking layer on the side thereof which faces the gel electrolyte and/or an anode which has been subjected to a hydrophilization treatment.

The present invention also provides a direct liquid fuel cell which is portable and comprises (i) a gel electrolyte comprising water, an alkali metal hydroxide, at least one polymeric gelling agent comprising one or more of a cross-linked polyacrylic acid and a salt thereof, a cross-linked polyacrylamide, an alkali saponified polyacrylonitrile, xanthan gum, guar gum, a starch graft copolymer, a HASE polymer and carboxymethylcellulose and (ii) a liquid fuel comprising water, an alkali metal borohydride compound and an alkali metal hydroxide.

In one aspect, the alkali metal hydroxide of the gel electrolyte may comprise KOH.

In another aspect, the gel electrolyte may be present as a paste and may have a thickness of not more than about 0.8 mm and/or may have a conductivity of at least about 4×10⁻³ S/cm.

In yet another aspect, the borohydride compound may comprise NaBH₄.

In a still further aspect, the fuel cell may comprise an air-breathing cathode and/or an anode which has been subjected to a hydrophilization treatment.

As set forth above, a preferred example of an aqueous gel electrolyte for use in a fuel cell of the present invention may comprise water, an alkaline compound such as, e.g., an inorganic hydroxide, and a gelling agent. Non-limiting examples of inorganic hydroxides include alkali and alkaline earth metal hydroxides such as, e.g., NaOH, KOH, LiOH, Ca(OH)₂ and Mg(OH)₂, with KOH being particularly preferred. The inorganic hydroxide usually is present to provide an at least about 2 N aqueous solution, e.g., an at least about 3 N, at least about 4 N or at least about 5 N aqueous solution.

The gelling agent will usually comprise a polymeric substance such as, e.g., an organic polymer, which is capable of swelling in the presence of an aqueous alkaline solution (if an alkaline aqueous electrolyte solution is used in combination therewith). Non-limiting examples thereof include polymers which are used as absorbent materials (e.g., as superabsorbents) in articles such as diapers and sanitary napkins. Examples of such materials include polymers of water soluble acrylic or vinyl monomers that are cross-linked with a polyfunctional reactant. Also included are starch modified polyacrylic acids and hydrolyzed polyacrylonitrile and their alkali metal salts. Non-limiting examples of superabsorbent polymers which are suitable for use as gelling agents in the present invention are described in, e.g., U.S. Pat. No. 4,990,541, the entire disclosure whereof is incorporated by reference herein.

The gelling agents may be (and preferably are) cross-linked and/or may comprise hydrophilic functional groups such as OH, COOH, CONH₂ and SO₃H, optionally in neutralized form. Non-limiting specific examples of superabsorbent polymers include cross-linked polyacrylic acid, cross-linked polyacrylamide, alkali saponified polyacrylonitrile, xanthan gum, starch graft copolymer, cross-linked carboxymethylcellulose and salts of these polymers such as, e.g., the sodium salts. Examples of corresponding commercially available products include SANWET®, a starch grafted polyacrylate sodium salt; DRYTECH® 520 SUPERABSORBENT POLYMER available from Dow Chemical Co., Midland, Mich. (a superabsorbent derived from polypropenoic acid); AQUA KEEP manufactured by Seitetsu Kagaku Co., Ltd.; ARASORB® manufactured by Arakawa Chemical (USA) Inc.; ARIDALL® 1125 manufactured by Chemdall Corporation; ALCOSORB® GI; CARBOPOL® 940 and 934 from B.F. Goodrich; FAVOR® from Stockhausen, Inc., and WATERLOCK® starch graft copolymers from Grain Processing Corporation, Muscatine, Iowa. Of course, other gelling agents can be used as well. Examples thereof include HALS (hydrophobically modified alkali soluble emulsion) polymers (see, e.g., U.S. Pat. No. 6,063,857, the entire disclosure whereof is incorporated by reference herein), homo- and copolymers of vinyl alcohol (e.g., polyvinylalcohol and ethylene/vinyl alcohol copolymers) and polyvinylacetate, poly(2-hydroxyethyl methacrylate)/-poly(ethylene oxide), isobutylene-maleic acid copolymer derivatives, polyvinylpyrrolidone, and poly(methacrylic acid) and salts thereof.

In addition to the gelling agent, the gel electrolyte of the fuel cell of the present invention may contain one or more additional materials which do not have pronounced gelling properties, if any, but show other desirable properties. For example, the additional material(s) may impart structural strength to the gel electrolyte. By way of non-limiting example, additional materials for use in the gel electrolyte include polymeric materials which may function as “matrix” materials for the polymeric gelling agent(s), i.e., increase the structural strength of the gel electrolyte. Non-limiting specific examples of such polymers include cellulose esters, polyacrylates, polyvinyl esters, acrylate/vinyl ester copolymers and combinations thereof.

The gel electrolyte for use in the fuel cell of the present invention may further comprise a particulate material in the form of, e.g., powders and/or fibers. The particulate material may, for example, comprise a hydrophilic, non-conductive material such as, e.g., cellulose, silica, silicon carbide, alumina, zirconia, a clay mineral, and an ion-exchange material such as a zeolite.

In another embodiment of the gel electrolyte, a porous matrix material such as, e.g., a sponge or foam, may be impregnated with a liquid electrolyte such as, e.g., an aqueous hydroxide solution.

Those of skill in the art will appreciate that the gel electrolyte for the direct liquid fuel cell of the present invention is not limited to the materials discussed above. For example, the alkaline electrolyte may be replaced by an acidic electrolyte and/or the predominant ion-transporting substance of the electrolyte may be or include a polymeric material. Also, the water may in part or completely be replaced by organic solvent(s). Non-limiting examples of further gel electrolytes and materials which are suitable for use in the present invention are described in, e.g., U.S. Pat. Nos. 4,031,037, 4,537,840, 5,585,208, 5,658,685, 5,766,787, 6,395,428, 6,509,123, 6,465,134, 5,639,573 and 6,468,696, the entire disclosures whereof are incorporated by reference herein.

The thickness of the gel electrolyte for the fuel cell of the present invention, particularly for a portable fuel cell, will preferably not exceed about 2 mm and may, for example, be not higher than about 1.5 mm, e.g., not higher than about 1 mm, or even not higher than about 0.8 mm. The thickness of the gel electrolyte will usually be at least about 0.2 mm, e.g., at least about 0.4 mm. Further, the conductivity of the gel electrolyte is preferably at least about 1×10⁻³ S/cm, e.g., at least about 2×10⁻³ S/cm, at least about 3×10⁻³ S/cm, or at least about 4×10⁻³ S/cm.

The liquid fuel for the fuel cell of the present invention comprises a hydride compound such as, e.g., a metal hydride compound and/or a borohydride compound such as, e.g., one or more of NaBH₄, KBH₄, LiBH₄, Be(BH₄)₂, NH₄BH₄, a polyborohydride, Ca(BH₄)₂, Mg(BH₄)₂, Zn(BH₄)₂, Al(BH₄)₃, (CH₃)₂NHBH₃, NaCNBH₃, LiH, NaH, KH, CaH₂, BeH₂, MgH₂, NaAlH₄, LiAlH₄, and KAlH₄. Non-limiting examples of suitable polyborohydride compounds include those of formulae MB₃H₈, M₂B₁₀H₁₀, MB₁₀H₁₃, M₂B₁₂H₁₂ and M₂B₂₀H₁₈ wherein M may be Li, Na, K, NH₄, Be_{1/2}, Ca_{1/2}, Mg_{1/2}, Zn_{1/2} or Al_{1/3} (the fractions associated with Ca, Mg, Zn and Al take into account that these metals are bi- or trivalent). Further examples of polyborohydride compounds which are suitable for use in the present invention are disclosed in, e.g., U.S. Patent Application Publication 2005/0132640 A1, the entire disclosure whereof is incorporated by reference herein. Preferably, the liquid fuel comprises at least a borohydride compound. Preferred borohydride compounds include NaBH₄ and KBH₄.

Preferably, the hydride and/or borohydride compound is dissolved and/or dispersed in an aqueous solvent. For example, the liquid fuel may be a solution and/or a suspension. In addition to water, the solvent may include a water-miscible organic solvent such as, e.g., a monohydric or polyhydric alcohol, for example, methanol, ethanol, propanol, isopropanol, butanol, pentanol, hexanol, ethylene glycol, propylene glycol, glycerol or any combination of two or more thereof.

The liquid fuel of the present invention may further comprise an alkaline substance, preferably a metal hydroxide such as LiOH, NaOH, KOH, RbOH, CsOH, Ca(OH)₂, Mg(OH)₂, Ba(OH)₂, and NH₄OH, preferably, NaOH and/or KOH, for example, in order to provide an alkaline pH and/or stabilize the (boro)hydride compound.

Non-limiting examples of liquid fuels for use in the fuel cell of the present invention are described in, e.g., US 20010045364 A1, US 20030207160 A1, US 20030207157 A1, US 20030099876 A1, and U.S. Pat. Nos. 6,554,877 B2 and 6,562,497 B2, the entire disclosures whereof are incorporated by reference herein.

The gel electrolyte for use in the fuel cell of the present invention is in contact with a cathode on one side and with an anode on the other side. Examples of cathodes and anodes for use in the present invention include those which are conventionally used in fuel cells. For example, the cathode may be an air-breathing cathode.

The anode of the present invention may be any anode which is suitable for the present type of fuel and DLFC. The anode will usually comprise a porous material that is pervious to gaseous and liquid substances, and may have been produced by wet or dry technologies. Of course, the materials thereof should be chemically stable with respect to the fuel. A non-limiting example of an anode for use in the present invention comprises a metal mesh current collector, e.g., a nickel or stainless steel mesh, which has attached to it a porous active layer. This active layer may comprise, by way of non-limiting example, activated carbon carrying a catalytically active material (such as a metal, for example Pt, Pd, Ru, Rh, to name just a few), and a binder, typically a polymeric material such as polytetrafluoroethylene, and the like. Of course, other materials for making the anode of the present invention may be used as well. For example, instead of the metal mesh, a metal foam, or hydrophilic carbon paper may be used.

In a preferred aspect, the anode of the fuel cell of the present invention has been subjected to a hydrophilization treatment on at least that side thereof which comes into contact with the liquid fuel. A suitable hydrophilization treatment is described in detail in co-pending U.S. application Ser. No. 11/325,466, the entire disclosure whereof is incorporated by reference herein.

In another aspect, the anode of the fuel cell of the present invention may carry a gas-blocking layer on the side thereof which comes into contact with the gel electrolyte. An example of an anode with a gas-blocking layer which is suitable for the fuel cell of the present invention is described in detail in co-pending U.S. application Ser. No. 11/325,326 the entire disclosure whereof is incorporated by reference herein.

### BRIEF DESCRIPTION OF THE DRAWING

The present invention is further described in the detailed description which follows, in reference to the noted drawing by way of non-limiting examples of exemplary embodiments of the present invention, wherein the only FIGURE shows a schematic cross section view of a direct liquid fuel cell according to the present invention which includes a gel electrolyte.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawing making apparent to those skilled in the art how the several forms of the present invention may be embodied in practice.

As illustrated in the FIGURE, a liquid fuel cell according to the present invention comprises a cathode 1, an anode 2, an electrolyte 3 and a fuel chamber 4 which contains a hydride fuel in the form of, e.g., an alkaline aqueous solution of a hydride or borohydride compound such as sodium borohydride.

Electrolyte 3 is a gel electrolyte in the form of, e.g., an aqueous alkali metal hydroxide (e.g., NaOH and/or KOH) in combination with a hydrophilic gelling agent and other optional components such as, e.g., matrix polymer and/or powder/fiber of inorganic hydrophilic materials. Anode 2 separates fuel chamber 4 and gel electrolyte 3. Cathode 1 (e.g., an air-breathing cathode) and anode 2 together sandwich gel electrolyte 3. At anode 2 an oxidation of the liquid fuel takes place. At cathode 1 a substance, typically oxygen in ambient air, is reduced. At least a part of the side of anode 2 which faces fuel chamber 4 may have been subjected to a hydrophilization treatment. Further, the side of anode 2 which faces the gel electrolyte may have a gas-blocking layer thereon (not shown in the FIGURE).

The anode may be any anode which is suitable for a (direct) liquid fuel cell that uses a hydrophilic fuel. The anode will usually comprise a porous material and may have been produced by wet or dry technologies. Of course, the materials of the anode should be able to withstand the chemical attack by the liquid fuel and the electrolyte and should not catalyze a decomposition of the fuel to any appreciable extent. A non-limiting example of an anode for use in the present invention comprises a metal mesh current collector, e.g., a nickel or stainless steel mesh, which has attached to it a porous active layer. This active layer may comprise, by way of non-limiting example, activated carbon carrying a catalytically active material (such as a metal, for example, Pt, Pd, Ru, Rh, Ir, Re and Au to name just a few), and a binder, typically a polymeric material such as, e.g., polytetrafluoroethylene. Of course, other and/or additional materials may be used for making the anode.

### EXAMPLES

### Example 1

A test cell for electrodes (area 10 cm²) was assembled with cathode, anode (80 weight % supported catalyst, 20 weight % PTFE, Ni mesh) and gel electrolyte. The gel which contained 3.5 M KOH was pasted over the electrodes. The thickness of the gel electrolyte layer was 0.4 to 0.8 mm. The fuel chamber was filled with 20 ml of suspension fuel composed of 2.5 M KBH₄ and 4 M KOH in water. The cell was discharged at a constant current of 1 A up to a cell voltage cutoff of 0.2 V. Fuel was refilled several times without change of electrolyte. Discharge energy and maximal power are given in Table 1 below.

TABLE 1

| Refill # | Energy [W * h] | Max. Power [W] |
|---|---|---|
| 1 | 3.88 | 0.614 |
| 2 | 3.42 | 0.625 |
| 3 | 3.59 | 0.635 |
| 4 | 3.77 | 0.600 |
| 5 | 3.72 | 0.594 |

From the data in Table 1 it can be seen that the fuel based on potassium compounds demonstrates a relative stability of discharge energy and power over 5 refills.

### Example 2

Test cell, electrodes, gel electrolyte and discharge mode were the same as in Example 1. The fuel chamber was filled with 20 ml of suspension fuel composed of 3 M KBH₄ and 4 M NaOH in water. Discharge energy and maximal power are given in Table 2 below.

TABLE 2

| Refill # | Energy [W * h] | Max. Power [W] |
|---|---|---|
| 1 | 4.92 | 0.648 |
| 2 | 5.26 | 0.611 |
| 3 | 4.49 | 0.565 |
| 4 | 2.56 | 0.456 |

From the data in Table 2 it can be seen that the fuel based on a mixture of potassium and sodium compounds demonstrates degradation of the discharge energy and power over 4 refills.

### Comparative Example

Test cell, electrodes, fuel composition and discharge mode were the same as in Example 2. The electrolyte chamber (thickness 3 mm) was filled with 4 ml of aqueous solution containing 3 M KOH and 1 M NaOH. The electrolyte was changed with every fuel refill. Discharge energy and maximal power are given in Table 3 below.

TABLE 3

| Refill # | Energy [W * h] | Max. Power [W] |
|---|---|---|
| 1 | 3.66 | 0.564 |
| 2 | 4.35 | 0.553 |
| 3 | 3.44 | 0.554 |
| 4 | 3.69 | 0.546 |
| 5 | 4.26 | 0.528 |

From the data in Table 3 it can be seen that the discharge energy in the cell with liquid electrolyte (exchangeable) is stable over 5 refills. The power output of this cell is 15-20% below that of the cells with gel electrolyte (Examples 1 and 2).

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A direct liquid fuel cell, wherein the fuel cell comprises a gel electrolyte and a liquid fuel comprising at least one of a metal hydride compound and a borohydride compound.

2. The fuel cell of claim 1, wherein the fuel cell is a portable fuel cell.

3. The fuel cell of claim 1, wherein the fuel cell is refillable.

4. The fuel cell of claim l, wherein the gel electrolyte comprises an aqueous gel electrolyte.

5. The fuel cell of claim 4, wherein the aqueous gel electrolyte is alkaline.

6. The fuel cell of claim 5, wherein the aqueous gel electrolyte comprises an inorganic hydroxide.

7. The fuel cell of claim 6, wherein the inorganic hydroxide comprises an alkali metal hydroxide.

8. The fuel cell of claim 1, wherein the gel electrolyte comprises at least one gelling agent.

9. The fuel cell of claim 8, wherein the at least one gelling agent comprises an organic polymer.

10. The fuel cell of claim 8, wherein the at least one gelling agent comprises one or more of a cross-linked polyacrylic acid and a salt thereof, a cross-linked polyacrylamide, an alkali saponified polyacrylonitrile, xanthan gum, guar gum, a starch graft copolymer, a HASE polymer and carboxymethylcellulose.

11. The fuel cell of claim 9, wherein the at least one gelling agent further comprises a matrix material.

12. The fuel cell of claim 11, wherein the matrix material is selected from cellulose esters, polyacrylates, polyvinyl esters, acrylate/vinyl ester copolymers and combinations thereof.

13. The fuel cell of claim 1, wherein the gel electrolyte comprises a particulate material selected from one or more of cellulose, silica, silicon carbide, alumina, zirconia, and a clay mineral.

14. The fuel cell of claim 13, wherein the particulate material comprises at least one of a powder and fibers.

15. The fuel cell of claim 1, wherein the gel electrolyte has a thickness of not more than about 2 mm.

16. The fuel cell of claim 1, wherein the gel electrolyte comprises a paste.

17. The fuel cell of claim 1, wherein the gel electrolyte has a conductivity of at least about 10⁻³ S/cm.

18. The fuel cell of claim 1, wherein the liquid fuel comprises a borohydride compound.

19. The fuel cell of claim 18, wherein the borohydride compound comprises at least one of NaBH₄, KBH₄, LiBH₄, Be(BH₄)₂, NH₄BH₄, a polyborohydride, Ca(BH₄)₂, Mg(BH₄)₂, Zn(BH₄)₂, Al(BH₄)₃, (CH₃)₂NHBH₃ and NaCNBH₃.

20. The fuel cell of claim 18, wherein the borohydride compound comprises an alkali metal borohydride.

21. The fuel cell of claim 1, wherein the liquid fuel comprises water.

22. The fuel cell of claim 21, wherein the liquid fuel further comprises an alkali metal hydroxide.

23. The fuel cell of claim 1, wherein the liquid fuel comprises a solution.

24. The fuel cell of claim 1, wherein the liquid fuel comprises a dispersion.

25. The fuel cell of claim 1, wherein the fuel cell comprises an air-breathing cathode.

26. The fuel cell of claim 1, wherein the fuel cell comprises an anode which comprises a gas-blocking layer on a side thereof which faces the gel electrolyte.

27. The fuel cell of claim 1, wherein the fuel cell comprises an anode which has been subjected to a hydrophilization treatment.

28. A direct liquid fuel cell, wherein the fuel cell is portable and comprises (i) a gel electrolyte comprising water, an basic inorganic compound and at least one polymeric gelling agent and (ii) a liquid fuel comprising water and a borohydride compound.

29. The fuel cell of claim 28, wherein the fuel cell is refillable.

30. The fuel cell of claim 28, wherein the gel electrolyte comprises an alkali metal hydroxide.

31. The fuel cell of claim 30, wherein the alkali metal hydroxide comprises KOI.

32. The fuel cell of claim 28, wherein the at least one polymeric gelling agent comprises one or more of a cross-linked polyacrylic acid and a salt thereof, a cross-linked polyacrylamide, an alkali saponified polyacrylonitrile, xanthan gum, guar gum, a starch graft copolymer, a HASE polymer, and carboxymethylcellulose.

33. The fuel cell of claim 32, wherein the at least one gelling agent further comprises a matrix material.

34. The fuel cell of claim 33, wherein the matrix material is selected from cellulose esters, polyacrylates, polyvinyl esters, acrylate/vinyl ester copolymers and combinations thereof.

35. The fuel cell of claim 28, wherein the gel electrolyte has a thickness of not more than about 1 mm and a conductivity of at least 10⁻³ S/cm.

36. The fuel cell of claim 28, wherein the gel electrolyte is present as a paste.

37. The fuel cell of claim 28, wherein the borohydride compound comprises at least one of NaBH₄, KBH₄, LiBH₄, Be(BH₄)₂, NH₄BH₄, a polyborohydride, Ca(BH₄)₂, Mg(BH₄)₂, Zn(BH₄)₂, Al(BH₄)₃, (CH₃)₂NHBH₃ and NaCNBH₃.

38. The fuel cell of claim 37, wherein the borohydride compound comprises NaBH₄.

39. The fuel cell of claim 28, wherein the liquid fuel further comprises an alkali metal hydroxide.

40. The fuel cell of claim 28, wherein the fuel cell comprises an air-breathing cathode.

41. The fuel cell of claim 28, wherein the fuel cell comprises an anode which has a gas-blocking layer on a side thereof which faces the gel electrolyte.

42. The fuel cell of claim 41, wherein the fuel cell comprises an anode which has been subjected to a hydrophilization treatment.

43. A direct liquid fuel cell, wherein the fuel cell is portable and comprises (i) a gel electrolyte comprising water, an alkali metal hydroxide, at least one polymeric gelling agent comprising one or more of a cross-linked polyacrylic acid and a salt thereof, a cross-linked polyacrylamide, an alkali saponified polyacrylonitrile, xanthan gum, guar gum, a starch graft copolymer, a HASE polymer, and carboxymethylcellulose and (ii) a liquid fuel comprising water, an alkali metal borohydride compound and an alkali metal hydroxide.

44. The fuel cell of claim 43, wherein the alkali metal hydroxide of the gel electrolyte comprises KOH.

45. The fuel cell of claim 44, wherein the gel electrolyte is present as a paste and has a thickness of not more than about 0.8 mm.

46. The fuel cell of claim 45, wherein the gel electrolyte has a conductivity of at least about 4×10⁻³ S/cm.

47. The fuel cell of claim 44, wherein the borohydride compound comprises NaBH₄.

48. The fuel cell of claim 43, wherein the fuel cell comprises an air-breathing cathode.

49. The fuel cell of claim 43, wherein the fuel cell comprises an anode which has been subjected to a hydrophilization treatment.
